(19) United States
(12) Patent Application Publication
(10) Pub. No.: US 2009/0243854 A1
(43) Pub. Date: Oct. 1, 2009

(54) WIRELESS AIRCRAFT MAINTENANCE LOG

(76) Inventors: Paul Raymond Scheid, West Hartford, CT (US); William H. Beacham, Enfield, CT (US); Alexey Sergeev Ouzounov, Bolton, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/055,345

(22) Filed: Mar. 26, 2008

(51) Int. Cl. G08B 13/22

(52) U.S. Cl. 340/572.1

(57) ABSTRACT

A method of aircraft maintenance involves storing part information relating to an aircraft part on the aircraft part. The part information is wirelessly transmitting from the aircraft part to a receiver. A note of a change relating to the aircraft part is made. The part information with the note of the change relating to the aircraft part is electronically stored at a location remote from the aircraft part.

### BACKGROUND OF THE INVENTION

This invention relates to a method and assembly for aircraft maintenance.

An aircraft generally has a life cycle that can extend over decades. As the aircraft ages, parts on the aircraft are repaired or replaced. Through this life cycle, the parts may become subject to design modification and revision. Because these changes in the parts of the aircraft may affect its operation, the Federal Aviation Administration requires airlines and maintenance organizations to keep a maintenance log of the parts, which are repaired or replaced on the aircraft.

In the field, a maintenance technician typically enters by hand changes to the parts of the aircraft into the log. This process is both time consuming and subject to error. A technician may even forget to record changes in the first place, especially if the repairs are conducted in the evening and the technician leaves record keeping for the next morning.

A need therefore exists for a method of aircraft maintenance that records changes about an aircraft conveniently and easily.

### SUMMARY OF THE INVENTION

A method of aircraft maintenance involves storing part information relating to an aircraft part on the aircraft part. The part information is wirelessly transmitting from the aircraft part to a receiver. A note of a change relating to the aircraft part is made. The part information with the note of the change relating to the aircraft part is electronically stored at a location remote from the aircraft part.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 illustrates a schematic view of an aircraft part with an RFID tag.

FIG. 2 illustrates a schematic view of a system for aircraft maintenance employing parts with RFID tags.

FIG. 3 illustrates a method of aircraft maintenance.

FIG. 4 illustrates a schematic view of an aircraft part with a bar code tag.

### DETAILED DESCRIPTION OF THE PREFERRED EMBODIMENT

With reference to FIG. 1, there is shown a schematic illustration of aircraft part 14 with RFID tag 18, a radio frequency identification tag. RFID tag 18 has a receiver/transmitter 22, memory unit 26, and processor 30. RFID tag 18 may be powered by battery or by radio frequency waves transmitted by another device, such as a remote transmitter.

In the past, information relating to an aircraft part, such as its part number or serial number, was placed on a label on the part by the manufacturer. If this part were repaired or replaced, a maintenance technician would have to record the number by hand at the aircraft and then subsequently enter this information into a log book or computer maintained away from the aircraft. Such a process relies heavily on the maintenance technician to record the part information accurately.

With RFID tag 18 on aircraft part 14, information relating to the aircraft part can communicated and recorded to another location with ease and accuracy as will be explained. RFID tag 18 has memory unit 26, which is both electronically readable and writable. Memory unit 26 can store part information relating to aircraft part 14, such as its part number, serial number, and part configuration (the specific design of the part). In addition, memory unit 26 is writable and can store transmitted part information, such as the service and revision history of aircraft part 14, including any changes or revisions to aircraft part 14 made by a maintenance technician. The types of information stored on memory unit 26 are not limited to the foregoing information but may include other types of information useful in the repair, maintenance and tracking of aircraft part 14.

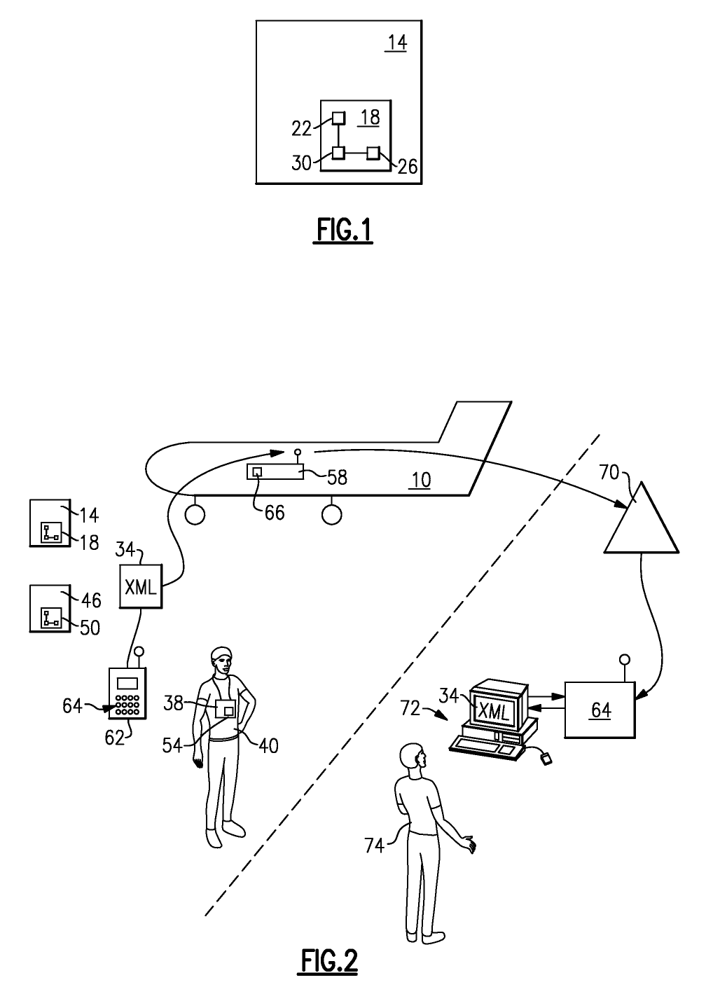

Processor 30 is provided to control both memory unit 26 and receiver/transmitter 22 so as to permit the accessing of information stored in memory unit 26, such as part information, as well as its revision by a remote device, such as portable device 62 (shown in FIG. 2). Receiver/transmitter 22 broadcasts and receives information through radio frequency signals. A signal to receiver/transmitter 22 by portable device 62 prompts processor 30 to release and transmit part information from memory unit 26 as well as receive and store information from portable device 62.

With reference to FIG. 2, RFID tag 18 is illustrated with other elements of the inventive technique and system. Maintenance technician 40 is shown carrying portable device 62, such as a personal digital assistant, having both electronically readable and writable memory, processor, display and keyboard as well as a radio frequency receiver and transmitter. Portable device 62 is used by maintenance technician 40 to access and write part information on RFID 18 by communicating with RFID 18 through a radio frequency signal. In addition, portable device 62 has programming that permits the formatting of information, such as part information, into electronic document 34. Electronic document may be an XML format that permits posting of information on the internet.

In addition, maintenance technician 40 is shown wearing identification badge 38 with RFID tag 54, which is constructed in the same manner as RFID tag 18. RFID tag 54 contains information relating to the identification of the maintenance technician as well as security verification information that permits maintenance technician 40 access to portable device 62 as well as RFID tag 18.

Aircraft 10 is also shown having aircraft computer 58, which acts as a server for portable device 62. Portable device 62 communicates wirelessly with aircraft computer 58 through radio frequency waves. Accordingly, aircraft computer 58 is linked with a receiver and transmitter for communication with portable device 62 as well as cell tower 70 or other relay device, such as a satellite. Cell tower 70 is in communication with second server 64, which is a computer located at a remote location such as a maintenance organization or airline facility. Second server 64 is linked with computer 72 with display and keyboard. With proper authorization, worker 74 has access to computer 72.

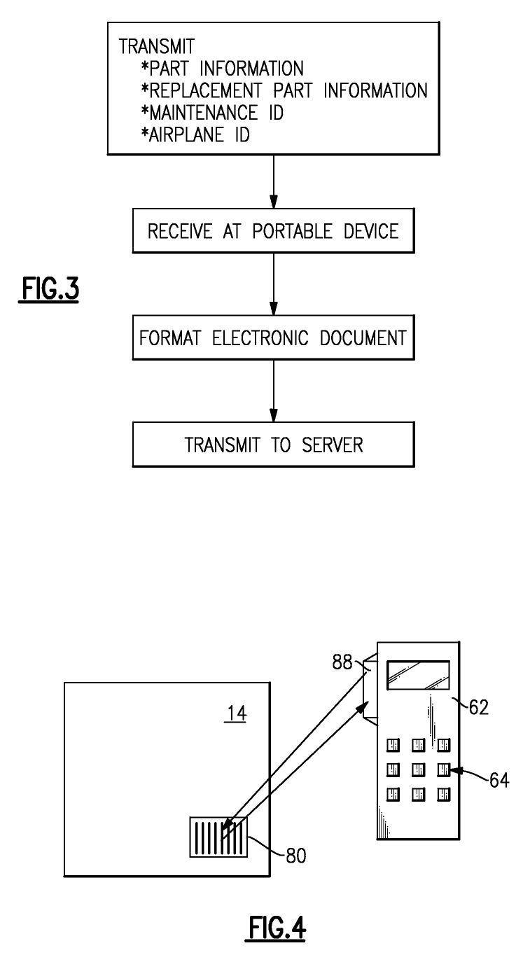

With reference to FIG. 2 and 3, the method for aircraft maintenance will now be explained. Maintenance technician 40 removes or otherwise services aircraft part 14. Using portable device 62, maintenance technician 40 prompts RFID tag 18 to transmit part information to portable device 62, which stores information in its memory. This part information is stored on portable device 62 when aircraft part 14 is either repaired or replaced. Maintenance technician 40 inputs into portable device 62 by say keyboard 64 a notation of any change made to aircraft part 14, such as whether aircraft part 14 was repaired or replaced. For example, if aircraft part 14 is repaired, maintenance technician 40 can input the type and nature of repair as well as the date of repair into memory of portable device 62. This information can later be transmitted to a remote location as will be explained. Portable device 62 may even have programming that walks maintenance technician 40 through the repair of aircraft part 14 step by step.

Alternatively, the change may be a replacement of aircraft part 14 by another aircraft part, such as replacement part 46. Like aircraft part 14, replacement part 46 has RFID tag, here RFID tag 50. RFID tag 50 stores replacement part information, which may be the same type of information as found on RFID tag 18, such as revision history of the part, part configuration, service history, part number, serial number and other related information. Through portable device 62, maintenance technician 40 prompts RFID tag 50 of replacement part 46 to wirelessly transmit replacement part information to portable device 62. Portable device 62 then stores replacement part information in memory along with the previously stored part information relating to aircraft part 14. Maintenance technician 40 then uses keyboard 64 on portable device 62 to record that replacement part 46 has replaced aircraft part 14.

Maintenance technician 40 then prompts portable device 62 to obtain information relating to the identity of maintenance technician 40 from RFID tag 54 and information relating to the identification of aircraft 10. To facilitate obtaining information about aircraft 10, aircraft 10 may have RFID tag 66, which records its identification number, such as its manufacturer's identification number or the identity of the aircraft in the fleet. Once this information is obtained, then portable device 62 formats part information, replacement part information (if part is replaced), aircraft identification, maintenance technician identification and notes concerning the nature of service, such as a note that the part has been changed, into electronic document 34, which is formatted in XML.

Portable device 62 transmits electronic document 34 to a remote location, such as aircraft computer 58, which then relays electronic document 34 to cell tower 70, which passes electronic document 34 to second server 64 through the internet. Computer 72 then displays electronic document 34 to permit viewing by worker 74, who is located at the remote facility. Electronic document 34 may be stored by second server 64 as well as aircraft computer 58 and portable device 62.

In addition, portable device 62 can further write information wirelessly onto RFID tag 18 as well as RFID tag 50. Maintenance technician 40 can accordingly input into both or either RFID tags 18 and 50 information relating to the maintenance of these parts as well as other notes. In this way, a service history of the part can be maintained with the part to facilitate the future use and/or repair of these parts.

Also, in lieu of using RFID tag 18 to store information, aircraft part 14 can be provided with barcode tag 80 as shown in FIG. 4. Barcode tag 80 would contain part information, such as part number, serial number and cage code. If barcode tag 80 is employed in lieu of RFID tag, portable device 62 would have laser scanner 88 to read wirelessly transmitted information from barcode tag 80.

The foregoing description shall be interpreted as illustrative and not in any limiting sense. A worker of ordinary skill in the art would recognize that certain modifications would come within the scope of this invention. For that reason, the follow claims should be studied to determine the true scope and content of this invention.

We claim:

1. A method of aircraft maintenance, comprising the steps of:
(a) storing part information relating to an aircraft part on the aircraft part;
(b) wirelessly transmitting the part information from the aircraft part to a receiver;
(c) making a note of a change relating to the aircraft part; and
(d) electronically storing the part information with the note of the change relating to the aircraft part at a location remote from the aircraft part.

2. The method of claim 1 including the step of:
(e) wirelessly transmitting the part information with the note of the change relating to the aircraft part to the location remote from the aircraft part.

3. The method of claim 2 including the step of:
(f) formatting the part information and the note of the change relating to the aircraft part into an electronic document for transmission to the location remote from the aircraft part.

4. The method of claim 1 wherein the part information relates to at least one of a revision history of the aircraft part, a service history of the part, a part configuration of the aircraft part, a part number of the part, and a serial number of the part.

5. The method of claim 1 including the step of:
(g) storing an identification of a maintenance technician serving the aircraft part;
(h) wirelessly transmitting the stored identification to the receiver; and
(i) electronically storing the wirelessly transmitted identification at the location remote from the aircraft part.

6. The method of claim 5 including the step of:
(j) verifying the identification of the maintenance technician servicing the aircraft part.

7. The method of claim 1 including the step of:
(k) replacing the aircraft part with a replacement aircraft part, the replacement aircraft part storing replacement part information;
(l) wirelessly transmitting the stored replacement part information from the replacement part to the receiver; and
(m) electronically storing the wirelessly transmitted replacement part information at the location remote from the aircraft part.

8. The method of claim 1 wherein the location remote from the aircraft part is on an aircraft computer.

9. The method of claim 1 wherein the location remote from the aircraft part is a server remote from an aircraft.

10. The method of claim 1 wherein the location remote from the aircraft part is on a portable device having a memory unit and processor.

11. The method of claim 10 wherein the receiver is on the portable device.

12. The method of claim 1 including the step of:
(p) storing an aircraft identification of an aircraft receiving the aircraft part;
(q) wirelessly transmitting the stored aircraft identification to the receiver; and
(r) electronically storing the wirelessly transmitted aircraft identification at the location remote from the aircraft part.

13. A method of aircraft maintenance, comprising the steps of:
(a) storing part information relating to an aircraft part on the aircraft part;
(b) replacing the aircraft part with a replacement aircraft part, the replacement aircraft part storing replacement part information;
(c) storing an identification of a maintenance technician servicing the aircraft part;
(d) wirelessly transmitting the stored part information, the stored identification, and the stored replacement part information to a receiver on a portable device having a memory unit and processor;
(e) formatting the wirelessly transmitted part information, the replacement part information and the identification into an electronic document; and
(f) wirelessly transmitting the electronic document to a server.

14. The method of claim 13 wherein the part information relates to at least one of a revision history of the aircraft part, a service history of the part, a part configuration of the aircraft part, a part number of the part, and a serial number of the part.

15. The method of claim 13 including the step of:
(g) verifying the identification of the maintenance technician servicing the aircraft part prior to electronically storing the transmitted electronic document.

16. The method of claim 13 wherein the server is on an aircraft serviced by the maintenance technician.

17. The method of claim 16 including the step of:
(h) relaying the electronic document from the server on the aircraft to another server located remotely from the aircraft.

18. The method of claim 13 including the step of:
(i) storing an aircraft identification of an aircraft receiving the aircraft part;
(j) wirelessly transmitting the stored aircraft identification to the receiver; and
(k) formatting the transmitted aircraft identification as part of the electronic document.

19. An aircraft part assembly, comprising:
an aircraft part for use on an aircraft;
a writeable memory unit storing part information;
a processor for processing the part information;
a wireless transmitter in communication with the writeable memory unit for transmitting the part information upon receiving a signal; and
a wireless receiver for receiving the signal.

20. The aircraft part assembly of claim 19 wherein the part information relates to at least one of a revision history of the aircraft part, a service history of the part, a part configuration of the aircraft part, a part number of the part, and a serial number of the part.
